(19) United States
(12) Patent Application Publication
(10) Pub. No.: US 2015/0042874 A1
(43) Pub. Date: Feb. 12, 2015

(54) IN-VEHICLE CAMERA

(71) Applicant: Nidec Elesys Corporation, Yokohama-shi (JP)

(72) Inventor: Naoya Takeda, Yokohama-shi (JP)

(73) Assignee: Nidec Elesys Corporation, Yokohama-shi (JP)

(21) Appl. No.: 14/269,232

(22) Filed: May 5, 2014

Related U.S. Application Data
(63) Continuation-in-part of application No. 13/962,611, filed on Aug. 8, 2013.

(51) Int. Cl. H04N 5/225

(52) U.S. Cl. CPC H04N 5/2252
USPC 348/374

(57) ABSTRACT

An in-vehicle camera that is provided with a substrate, a camera body, a housing including the substrate and the camera body. The substrate is provided with the opening, and the camera body is arranged at the position of the opening of the substrate. Furthermore, the camera body is included in the housing, with a part thereof inserted into the opening.

### CROSS REFERENCE TO RELATED APPLICATIONS

The present application is a Continuation-in-Part of U.S. application Ser. No. 13/962,611, filed Aug. 8, 2013, which application is incorporated herein by reference in its entirety by reference.

### BACKGROUND OF THE INVENTION

1. Field of the Invention

The invention relates to an in-vehicle camera, and more particularly, an in-vehicle camera mounted on a windshield to capture images of objects present in the frontward of a vehicle.

2. Description of the Related Art

An in-vehicle camera has been used for extracting images of on-road lane markings, an immediately preceding vehicle, an opposite vehicle, persons, traffic signs, road markings, and the like by processing images captured by the camera installed in the vehicle. Such an in-vehicle camera is also applied for an in-vehicle system for assisting safety driving of a vehicle, a monitoring system for detecting abnormalities and an intrusion of a suspicious person, and other systems.

As a typical example of these image-processing in-vehicle cameras to extract various pieces of information from an image, there is known the type which is mounted on a vehicle's windshield to monitor the forward of the vehicle. The requirements of these cameras include a narrower installation space. In recent years, a vehicle has come to be equipped with various sensors such as a rain sensor, an illuminance sensor, a millimeter-wave or a laser-radar sensor. This requires for an installation space of devices in a vehicle to be as small to install the devices as compactly as possible. Especially inside the vehicle, to avoid obstructing driving, it is required to install each device at a position or in a size that does not obstruct driver's vision nor give a feeling of oppression to the driver.

For the above requirements, an in-vehicle camera has been developed which is capable of being reduced in the attachment space on the windshield of a vehicle and includes a substrate, an imaging element 210 having an optical axis in a direction perpendicular to the surface of the substrate, a lens arranged on the optical axis, and a mirror changing a direction of the optical axis to the frontward of the vehicle as shown in, for example, Patent Document 1 below. Further, as a product relating to the in-vehicle camera, a vehicle-oriented accessory system is disclosed which contains an in-vehicle camera therein and includes a module being attached on the windshield for use as shown in, for example, Patent Document 2 below.

### RELATED DOCUMENTS

### Patent Documents

1. US patent document 2009-0046149 A1 (JP patent document 2009-40270 A)
2. US patent document 8405726-B2

A conventional in-vehicle camera, however, has a problem mentioned below.

The in-vehicle camera disclosed in the patent document 1 includes an optical module (a camera body) provided with a lens and a mirror, arranged at the outer frontward of the substrate. This has caused a problem that when the in-vehicle camera is attached on the windshield of the vehicle, the in-vehicle camera becomes large in a size in an oblique front-rear direction of a vehicle.

An invention disclosed in the other US patent document No. 2 relates to a vehicle-oriented accessory system, and it is not considered to make smaller the attachment space of the camera to a windshield. Thus, the module disclosed in the patent document No. 2 is not intended for miniaturization.

### SUMMARY OF THE INVENTION

Accordingly, an object of the invention is to provide an in-vehicle camera that is able to be made smaller in its external dimensions.

In order to solve the above mentioned problem, an in-vehicle camera according to an embodiment of the invention includes a substrate; a camera body; and a housing including the substrate and the camera body. The substrate is provided with an opening and the camera body is attached at the position of the opening of the substrate.

According to the above structure, since the camera body is provided in the position of the opening of the substrate, the in-vehicle camera becomes shorter and smaller in its external dimensions. Additionally, since the camera body does not have a thick structure, the in-vehicle camera becomes thinner in its structure at its position.

The in-vehicle camera according to an embodiment of the invention preferably includes in the housing the camera body with a portion thereof inserted into the opening.

Such a structure makes the structure of the camera body in the in-vehicle camera further thinner and results in a further thinner structure of the in-vehicle camera at its position.

The in-vehicle camera according to an embodiment of the invention preferably includes the housing provided with a base housing supporting the substrate, and a cover housing facing to the base housing and supporting the camera body. The cover housing is preferably provided with a lens window part for the camera body, protruding from a surface of the cover housing. And the housing is preferably formed so that the housing becomes thinner from an end position of the lens window part toward an end portion of the housing.

According to such a structure, the in-vehicle camera becomes thinner from the end position of the lens window part toward the end portion of the in-vehicle camera. As a result, the in-vehicle camera becomes hard to come into view of a driver when the in-vehicle camera is attached to the windshield.

In the in-vehicle camera according to an embodiment of the invention, a processing-circuit element of the in-vehicle camera preferably contacts the housing through a heat-radiating member. According to such a structure, since the heat generated by the processing-circuit element is radiated from the heat-radiating member, the in-vehicle camera is improved in heat-radiating performance.

In the in-vehicle camera according to an embodiment of the invention, it is preferable that the substrate is provided with the opening at a center, an element that has an installation height from the substrate larger than a predetermined reference value at one side around the center, and another element that has an installation height from the substrate smaller than the predetermined reference value at the other side around the center. The fin member is preferably provided in a space facing to the other side around the opening of the substrate, and protruding from the housing toward the inner side.

According to such a structure, the in-vehicle camera includes the fin member in the inner side of the housing, thereby the surface area of the predetermined portion of the housing becomes larger and heat generated in the inner-side of the in-vehicle camera is radiated through the fin member, which improves heat-radiating performance of the in-vehicle camera.

In the in-vehicle camera according to an embodiment of the invention, the substrate is preferably 70 to 80 mm long in the longitudinal direction, and 50 to 60 mm in the lateral direction; the opening of the substrate is preferably 10 to 20 mm long in the longitudinal direction, and 15 to 25 mm in the lateral direction.

According to such a structure of the in-vehicle camera, by defining the sizes of the substrate and the opening as the above, the substrate can be made suitable in size, for each element of the in-vehicle camera to become easy to be installed onto the substrate. And the part of the camera body becomes easy to be inserted into the opening.

According to the in-vehicle camera of an embodiment of the invention, since the external dimensions of the in-vehicle camera can be made small, the attachment space to the windshield and the thickness of the in-vehicle camera can be made small. This prevents the in-vehicle camera from obstructing the frontward view of the driver when the in-vehicle camera is attached to the windshield.

### BRIEF DESCRIPTION OF THE DRAWINGS

FIG. 1 is an exploded perspective view showing a whole structure of the in-vehicle camera according to an embodiment of the invention.

FIG. 2 is an exploded side view showing a whole structure of the in-vehicle camera according to the embodiment.

FIG. 3 is a perspective view showing an external structure of the in-vehicle camera according to the embodiment.

FIG. 4 is a schematic view showing a situation in which the in-vehicle camera according to the embodiment is attached to the vehicle windshield.

FIGS. 5A and 5B are schematic views showing another embodiment of the in-vehicle camera according to the embodiment. FIG. 5A is a perspective view showing a situation in which the housing is provided with a fin member and a groove; and FIG. 5B is a top view showing a position relation of a fin member.

FIG. 6 is a view with part of the housing broken in FIG. 2.

FIG. 7 is an exemplary block diagram of the in-vehicle camera.

### DETAILED DESCRIPTION OF THE PREFERRED EMBODIMENT

Hereinafter, an embodiment of the in-vehicle camera is described in detail referring to the drawings. Note that sizes, position relations, or the like of members or the like showed in the drawings are sometimes magnified for clear description.

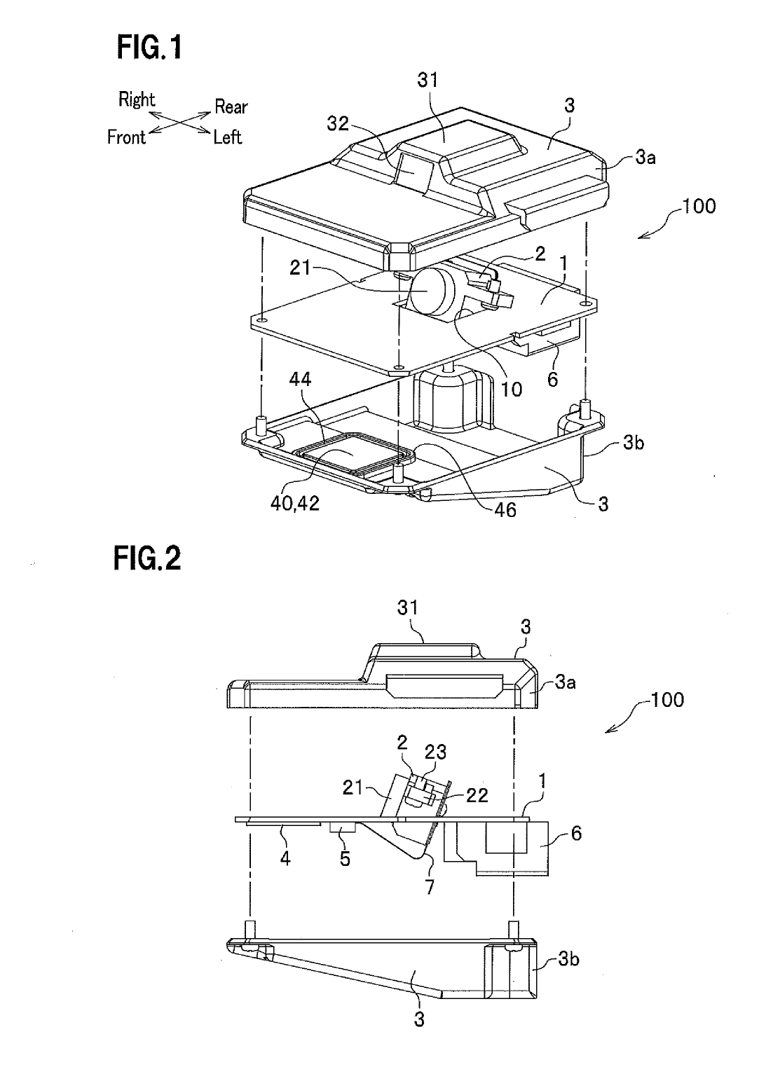

As shown in FIGS. 1 to 3, and 6, the in-vehicle camera 100 captures images while travelling. The in-vehicle camera 100 includes the substrate 1, the camera body 2, and the housing 3 including the substrate 1 and the camera body 2 therein.

Now, each member's structure is described.

The substrate 1 can store and transmit to another device an image or a video captured by the camera body 2. On the substrate 1, the camera body 2, a processing-circuit element 4, a first connector 5, a second connector 6, and the like are mounted. On a reverse face of the substrate 1 are arranged members (not shown) of the in-vehicle camera 100, such as a power supply circuit element, a condenser, a microcomputer, and ICs. In the present embodiment, the reverse face of the substrate 1 means a face opposite to a side on which the camera body 2 is arranged. Note that the surface of a substrate generally refers to a face on which elements are mounted. Applying this reference rule to the present embodiment, it can be said that the surface of the substrate 1 faces below in the housing 3.

The substrate 1 has a rectangular shape formed by sides in a longitudinal direction of the substrate 1 which is a front-rear direction in the in-vehicle camera 100 and sides in a lateral direction perpendicular to the longitudinal direction. Note that “the front-rear direction in the in-vehicle camera 100” is a direction along which the in-vehicle camera 100 captures an image, and means a direction along which an optical axis of the camera runs, as shown in FIG. 1. “The longitudinal direction” is a front-rear direction in FIG. 1 and a direction which becomes the oblique front-rear direction of the vehicle body when the in-vehicle camera 100 is attached to the windshield 50 (refer to FIG. 4). And, “the lateral direction” is the right-left direction in FIG. 1.

The size of the substrate 1 is not defined as a particular value, but for example, it is preferable that the length in the longitudinal direction of the substrate 1 is 70 to 80 mm, and that the length in the lateral direction of the substrate 1 is 50 to 60 mm. If the substrate 1 has this size, each member arranged on the substrate is easy to mount, and the in-vehicle camera 100 does not become larger than necessary.

The thickness of the substrate 1 is not also defined as a particular value, but for example, preferably 1.0 to 1.6 mm. When the thickness of the substrate 1 is in this range, the substrate 1 is kept in the strength to be free from problems for practical use, without becoming thicker than necessary.

The substrate 1 is provided with an opening 10. The opening 10 has a portion of the camera body 2 inserted therein as described later. And, through the opening 10 is passed a flexible print circuit board (FPC) 7 which electrically connects the camera body 2 with the first connector 5, as described later. Further, in the opening 10, the camera body 2 is arranged being overlapped with the substrate 1 in the direction of the depth of the substrate 1.

The opening 10 is a hole perforated in the substrate 1 at a predetermined position of the substrate 1 with a predetermined size. Here is arranged the opening 10 at a little backward from the center in the longitudinal direction of the substrate 1 (the opposite side to the direction for capturing an image), and at a point overlapping with the central point in the lateral direction of the substrate 1, for example the center. The size of the opening 10 is not defined as a particular value, and may be properly adjusted according to the sizes of the substrate 1 or the camera body 2. One example is that the longitudinal direction may be made 10 to 20 mm and the lateral direction may be made 15 to 25 mm. When the opening 10 has this size, each member to be arranged on the substrate 1 is easy to install onto the substrate, and a portion of the camera body is easy to insert into the opening 10. Each element installed on the substrate 1 is described later.

The camera body 2 is a device that captures an image from visual information including an object. The camera body 2 has a lens 21 arranged in a lens-storage part with a cylindrical form, and an imaging element 210 (not shown) is included at a focal point on an optical axis of the lens 21.

The lens 21 is arranged protruding at the frontward position of the camera body 2, and plural types of lenses are used together so that the depth of field is configured similar to a typical digital camera. The imaging element 210 is an element that captures outside visual information as an image. For an element used to capture an image, for example, CMOS (Complementary Metal Oxide Semiconductor) is used.

The camera body 2 is arranged at the position of the opening 10. Here, the camera body 2 is fixed to the housing 3 and a portion of the camera body 2 is inserted into the opening 10 of the substrate 1. That is, the portion of the camera body 2 is overlapped with the substrate 1 in the direction of the width thereof in a state in which the portion of the camera body 2 is arranged within the opening 10 while the camera body 2 is fixed to the cover housing 3a (i.e. a member that is one of members included in the housing 3 and that fixed to the windshield 50). Note that FIG. 1 shows the state in which the camera body 2 is separated from the cover housing 3a and arranged within the opening 10, for convenience of illustration.

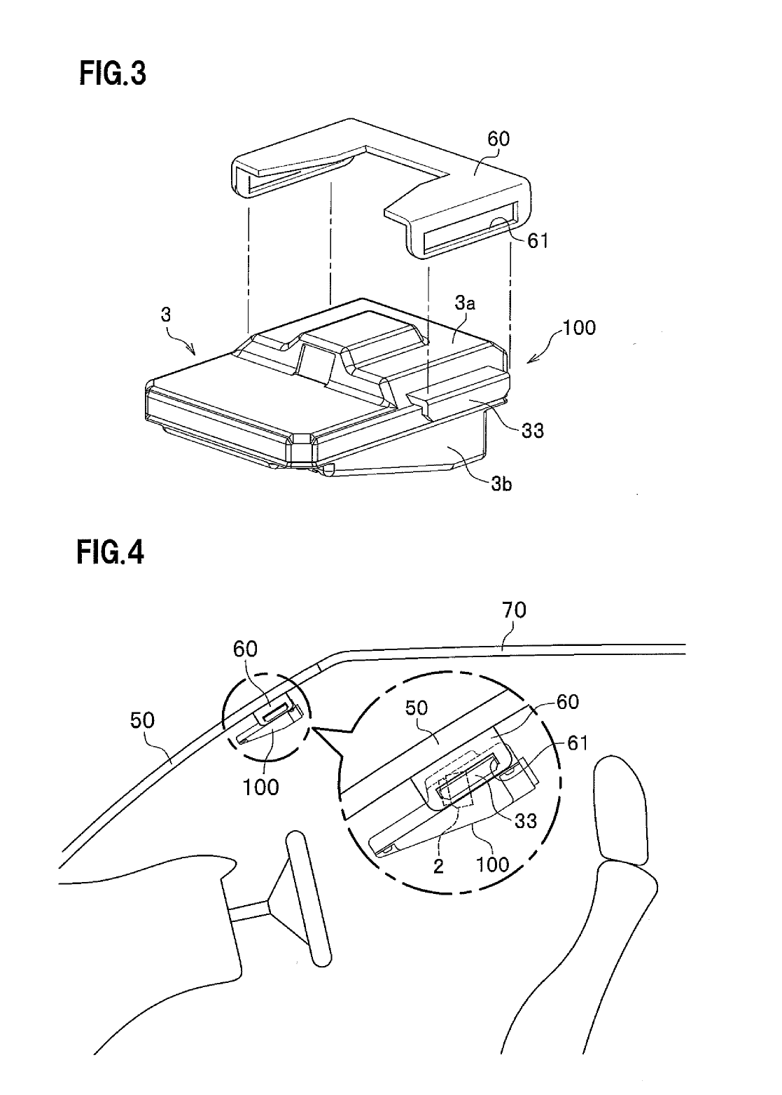

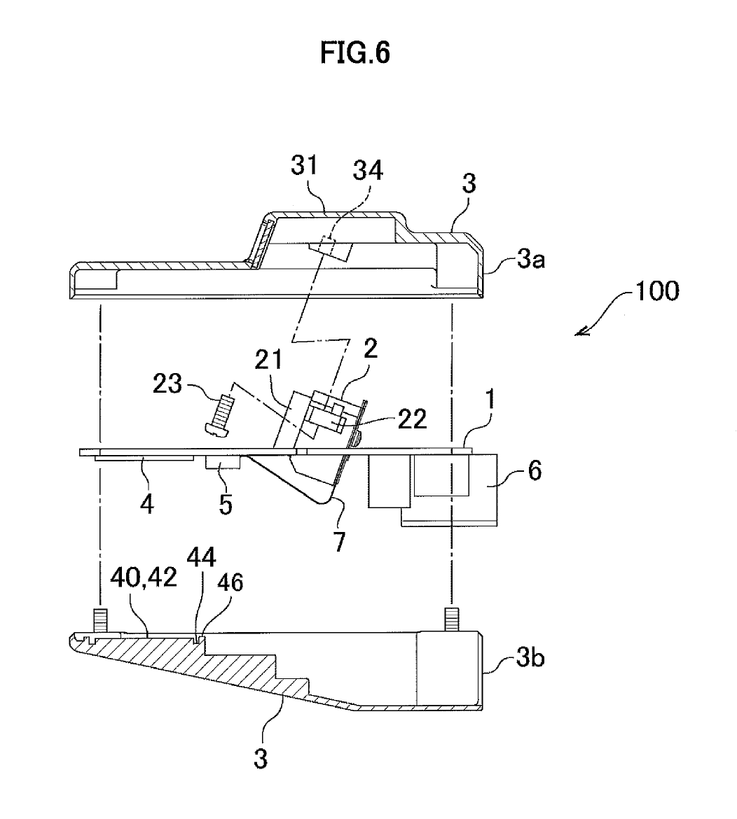

Specifically, as shown in FIGS. 2 and 6, the camera body 2 is provided with fixing protrusions 22 at the backward thereof and fixing members 23 inserted into a hole of the fixing protrusion 22. For the fixing member 23, for example, a bolt or a screw is used. The present embodiment uses a bolt for the fixing member 23. And, the camera body 2 is fixed to the inner side of the cover housing 3a with the fixing member 23. The camera body 2 is fixed to the cover housing 3a with a predetermined angle so that the direction of the lens 21, that is, the imaging direction of the camera body 2, faces toward a lens window opening 32 of the lens window part of the cover housing 3a. Then, when the substrate 1 is housed in the housing 3 (refer to FIG. 3) by putting together the cover housing 3a and the base housing 3b, for example, the bottom portion of the camera body 2 is inserted into the opening 10. The cover housing 3a includes a hole 34 into which the fixing member 23 is inserted. In the present embodiment, the hole 34 has threads formed in the inner wall thereof. The threads meshes with threads formed on the fixing member 23. Further, an adhesive can be used for fixing the camera body 2 to the cover housing 3a.

The depth of the bottom portion of the camera body 2 which is inserted into the opening 10 may not be defined as a particular value but adjusted properly according to the size of the camera body 2 or the housing 3. One example of the depth is 5 to 15 mm.

Thus, the in-vehicle camera 100 can have the place of the camera body 2 further thinner, by arrangement such that the camera body 2 is partly buried in the depth direction within the opening 10 of the substrate 1. This enables the in-vehicle camera 100 to become further thinner.

Additionally, since the in-vehicle camera 100 becomes easy to regulate the depth of by which the bottom of the camera body 2 is inserted into the opening 10 by arranging the camera body 2 at the position of the opening 10, the camera body 2 becomes easy to be regulated in the thickness in the in-vehicle camera 100. Furthermore, since providing the camera body 2 with the opening 10 prevents the bottom of the camera body 2 from getting contact with the substrate 1 regardless the angle of the camera body 2, the camera body 2 becomes easy to be arranged in the cover housing 3a at a predetermined angle.

And, being arranged at the position of the opening 10 of the substrate 1, the camera body 2 is arranged at the position that is a little backward from the center in the longitudinal direction of the substrate 1 (the opposite direction to the image capturing direction) and the center in the lateral direction. Additionally, being arranged at the position of the opening 10 of the substrate 1, the camera body 2 comes into the situation in which it is arranged within a plane surface of the substrate 1. “Being arranged within a plane surface of the substrate” is being arranged within a projection area of the substrate 1. It means that the camera body 2 is arranged so that a part of the camera body 2 does not extend beyond the edge of the substrate 1.

The housing 3 houses the substrate 1 and the camera body 2. Additionally, the housing 3 also includes the processing-circuit element 4, the first connector 5, the second connector 6, FPC7, and other members, which are all connected to the substrate 1.

Here, the housing 3 is provided with the base housing 3b supporting the substrate 1, and the cover housing 3a. The cover housing 3a opposes the base housing 3b and supports the camera body 2. For material of the housing 3, for example, aluminum or alloy thereof is considered, and sheet metal made of them can be used. Further, for material of the housing 3, resin can be also used.

In the cover housing 3a, the lens window part 31 for the camera body 2 protrudes from a surface of the cover housing toward the upper side of the drawings. The lens window part 31 is arranged at the position of the cover housing 3a where the camera body 2 is placed. The lens window part 31 is arranged at a portion in the cover housing 3a where the camera body 2 is placed. Thereby the camera body 2 can be contained within the housing 3, when the substrate 1 is housed in the housing 3.

The lens window part 31 has a form as protruding from the cover housing 3a according to the form of the camera body 2. And, in the lens window part 31, the lens window opening 32 is formed with a frontward portion opened where the lens is placed. This form enables the lens 21 of the camera body 2 to obtain information from the exterior of the vehicle. Furthermore, the cover housing 3a has a structure in which a housing thickness from the frontend position of the lens window part 31 to the frontend of the cover housing 3a is small. That is, the cover housing 3a is formed so that the housing becomes thinner from a predetermined position near the center to the frontend, compared from the predetermined position to the backward end.

Here, “the frontend position of the lens window part 31” is the forefront portion of the lens window part 31 in the direction to the end portion of the cover housing 3a and the portion where the bottom part of the lens window opening 32 is placed. And, “a housing thickness from the frontend position of the lens window part 31 to the frontend of the cover housing 3a is small” does not mean that the thickness is small only in the width of the lens window part 31 in the lateral direction of the cover housing 3a, but that the thickness is small in all the width of the cover housing 3a.

The base housing 3b has a cut-out formed at backward thereof, which enables a predetermined portion of the second connector 6 to be contained in the base housing 3b when the substrate 1 is housed in the housing 3. Note that a backward portion of the second connector 6 is exposed from the backward of the base housing 3b to the exterior of the housing 3.

At a position of the processing-circuit element 4 in the base housing 3b, a heat-radiating member 40 is provided. Additionally, the bottom of the base housing 3b has a structure in which the bottom slants from a predetermined position of the backend to the frontend. In other words, the housing thickness of the base housing 3b becomes thinner gradually from the predetermined position of the backend to the frontend.

Furthermore, the housing 3 is united by fixing the cover housing 3a and the base housing 3b to each other while being opposed with each other (refer to FIG. 3). The cover housing 3a and the base housing 3b can be removable from each other by using, for example, screws; or can be combined not to be removable from each other. In the former case, the screws are provided in four corners of the housing 3. Additionally, the screws may fix the substrate 1 to the base housing 3b. In this situation, since the cover housing 3a and the base housing 3b have the aforementioned shapes, the housing 3 becomes thinner from the frontend position of the lens window part 31 to the frontend of the housing 3.

That is, in the in-vehicle camera 100, the housing 3 becomes gradually thinner from the predetermined position at the backward (rear end) of the in-vehicle camera 100 to the frontend position of the lens window part 31, and becomes gradually thinner from the frontend position of the lens window part 31 to the frontward (front end) of the in-vehicle camera 100. Note that “the frontward of the in-vehicle camera 100” is a direction of the “Front” indicated in FIG. 1 and that “the backward of the in-vehicle camera 100” is a direction of the “Rear” indicated in FIG. 1.

Next, described is each element and the like mounted on the substrate 1.

The processing-circuit element 4 is an element that processes an image captured by the imaging element 210, and arranged at a predetermined position of a reverse face of the substrate 1. The processing-circuit element 4 performs extraction of various characteristic objects such as a vehicle, a pedestrian, a lane marking, and the like from visual information formed as an image on the imaging element 210. The processing-circuit element 4 is, for example, an element that has the largest heat quantity (or heat quantity per unit area) among the elements mounted on the substrate 1. Since the heat quantity of an element is proportional to the consumption electricity of the element, the processing-circuit element 4 is an element that has the largest consumption electricity among the elements mounted on the substrate 1.

Here, the processing-circuit element 4 contacts the base housing 3b through the heat-radiating member 40. For an example of the heat-radiating member 40, a heat-radiating plate/sheet, resin with high heat conductivity, or a heat-radiating gel can be used. For material of a heat-radiating plate/sheet, silicon-based material and the like may be used. For material of a heat-radiating gel, silicon-based material and the like may be also used. The processing-circuit element 4 generates heat when the in-vehicle camera 100 is powered on. Heat-radiating performance of the in-vehicle camera 100 can be improved by making the processing-circuit element 4 contact the heat-radiating member 40 to make the processing-circuit element 4 indirectly contact with the base housing 3b.

In a surface of the base housing 3b opposing to the substrate 1, a gap 44 is formed at the surrounding of a contact region 42 that contacts the processing-circuit element 4. And the base housing 3b is provided with a wall portion 46 surrounding the gap 44. The gap 44 and the wall portion 46 prevent a portion of the heating element 40 from protruding the contact region 42. Additionally, the bottom of the base housing 3b slants to the substrate 1, but the upper ends of the gap 44 and the wall portion 46 are substantially parallel to a surface other than the face facing to the substrate 1 (for example, the slant is equal to or higher than −5° and equal to or lower than +5°; preferably equal to or higher than −2° and equal to or lower than +2°). This makes it easy for the contact region 42 to contact the processing-circuit element 4 indirectly via the heating element 40. Note that the upper surface of the contact region 42 is lower than the upper surface of the wall portion 46 by for example, equal to or more 0.05 mm and equal to or less 1 mm.

Further, in the state in which the in-vehicle camera 100 is attached on a vehicle, the cover housing 3a locates on the side of the windshield 50 and the base housing 3b locates on the other side with the windshield 50 across the cover housing 3a. Therefore, heat generated in the processing-circuit element 4 is radiated to the vehicle compartment through the base housing 3b. And since the base housing 3b is easy to receive wind sent by a room air-conditioner, heat radiation efficiency is high at the base housing 3b. Further, according to the structure shown in FIG. 2, the processing-circuit element 4 locates closer to the windshield 50 than the opening 10. Therefore, when the wind is sent along the windshield 50, the wind is easy to blow against a portion of the base housing 3b overlapping with the processing-circuit element 4. This makes it easy to radiate the heat transferred from the processing-circuit element 4 to the base housing 3b.

The first connector 5 is a member to which the FPC7 is connected, and arranged at a predetermined position of the reverse face of the substrate 1. The first connector 5 transmits image data from the FPC7 to the processing-circuit element 4.

The second connector 6 (power connector) can perform power supply and communications, and arranged at a rear portion of the reverse face of the substrate 1. The second connector 6 supplies power from the vehicle to the in-vehicle camera 100, and outputs to the exterior a calculation result calculated by the processing-circuit element 4.

The second connector 6 is fixed on the reverse face of the substrate 1. This makes water invading into the second connector 6 being pooled in the bottom of the second connector 6 (i.e. the reverse side to the substrate 1) due to gravity. This suppresses the water from deteriorating the substrate 1.

The FPC7 is a member that electrically connects the camera body 2 with the first connector 5 mounted on a predetermined position of the reverse face in the substrate 1. The FPC7 is arranged at the backward of the camera body 2 and connected with the backward portion of the camera body 2 to be connected with the imaging element 210 in the camera body 2. The FPC 7 is further connected with the first connector 5 passing through the opening 10.

With the opening 10 on the substrate 1, the FPC7 can be shortened and the connection of the camera body 2 with the first connector 5 can be simplified.

Next, described is an attachment state of the in-vehicle camera 100.

As shown in FIG. 4, the in-vehicle camera 100 is attached on the inner side of the windshield 50 of the vehicle so that the cover housing 3a faces to the side of the windshield 50 and the frontward of the in-vehicle camera 100 is directed to the slantingly downward (slantingly frontward). That is, the in-vehicle camera 100 is attached so that the backward of the in-vehicle camera 100 is directed to the ceiling 70 and that the camera body 2 is placed at the side of the windshield 50.

The in-vehicle camera 100 is attached on the windshield 50 through an attaching member 60. The attaching member 60 is provided beforehand at a predetermined position of a windshield 50, for example, near a rearview mirror, fixed by double-sided tape, adhesive, or the like. The attaching member 60 has the in-vehicle camera 100 fitted therein. The attaching member 60 is provided with an engaging part 61. The attaching member 60 is fixed to the in-vehicle camera 100. Thereby, the in-vehicle camera 100 can be attached on the predetermined position of the windshield 50.

The lens 21 of the in-vehicle camera 100 is adjusted beforehand to be directed to the travelling direction of the vehicle when the in-vehicle camera 100 is attached to the windshield 50. An attachment position in a windshield 50 of the in-vehicle camera 100, and an angle of the lens 21 is preferably adjusted properly according to an object or the like to be imaged.

At the same time, since the in-vehicle camera 100 according to the embodiment of the invention is small in its external dimensions, its attachment space to the windshield 50 can be small. Also, the in-vehicle camera 100 becomes smaller in thickness thereof. Therefore, the in-vehicle camera 100 does not become an obstacle to the frontward view of the driver when attached to the windshield 50. Furthermore, the in-vehicle camera 100 becomes thinner in the direction from the predetermined position at the backward to the frontward of the in-vehicle camera 100. Therefore, the in-vehicle camera 100 does not become an obstacle to the frontward view of the driver and is further hard to come into the view, which reduces a feeling of discomfort given by the in-vehicle camera 100.

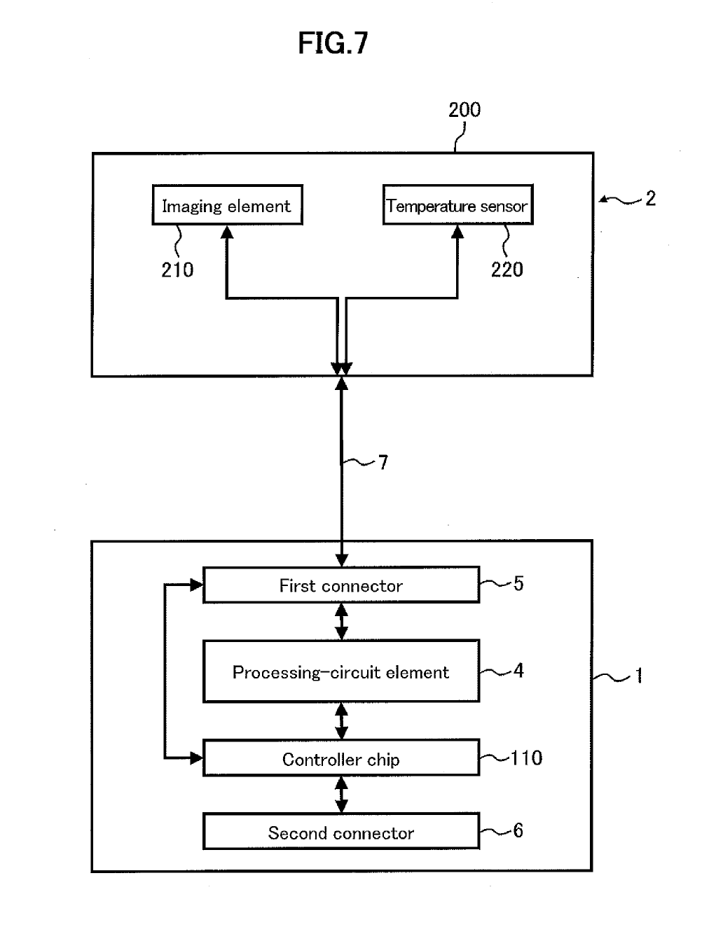

FIG. 7 is an exemplary block diagram showing electric connections of the in-vehicle camera 100. The camera body 2 is provided with the substrate 200. The substrate 200 is provided with an imaging element 210 (for example, CMOS camera) and peripheral circuits (not shown). On the substrate 200 is fixed with a temperature sensor 220 other than the imaging element 210. The temperature sensor 220 measures a temperature of the imaging element 210 and outputs the measured value to the substrate 1.

The substrate 1 has a controller chip 40 (for example, micro-computer) mounted on thereof, other than the processing-circuit element 4, the first connector 5, and the second connector 6. The controller chip 40 outputs control signals to the external on the basis of image processing results by the processing-circuit element 4. The control signals are used, for example, to assist a driver to drive a vehicle.

In addition, the controller chip 40 determines that the image data from the imaging element 210 is more likely to be deteriorated and stops to generate the control signals, in the case that the temperature detected by temperature sensor 220 exceeds a standard value. Furthermore, since the temperature sensor 220 is mounted on the substrate 200 in the example of FIG. 7, the temperature sensor 220 can measure the temperature of the imaging element 210 more precisely, compared with the case that the temperature sensor 220 is mounted on the substrate 1.

Next, described is the operation of the in-vehicle camera 100.

First, an electric current is supplied to the in-vehicle camera 100 via the second connector 6 from a power supply of the vehicle. The electric current is converted to a necessary voltage in a power supply circuit element, and then supplied to each microcomputer, each IC, and the like on the substrate 1.

Next, the lens 21 of the camera body 2 acquires external visual information, and forms an image of the visual information on the imaging element 210 in the camera body 2. The visual information formed as the image on the imaging element 210 is transmitted to the processing-circuit element 4 via the FPC 7 and the first connector 5. Then the processing-circuit element 4 performs extraction of various characteristic objects such as a vehicle, a pedestrian, a lane marking. Finally, the final calculation result calculated in the processing-circuit element 4 is outputted to the controller chip 110.

The above describes the invention in detail by showing the embodiments and implementation examples of the invention, but the subject matter of the invention should not be limited into the above-mentioned descriptions, and the scope of the patent-right of the invention should be understood widely based on the description of the claims. Note that the content of the invention can be, of course, widely revised and changed based on the above mentioned description.

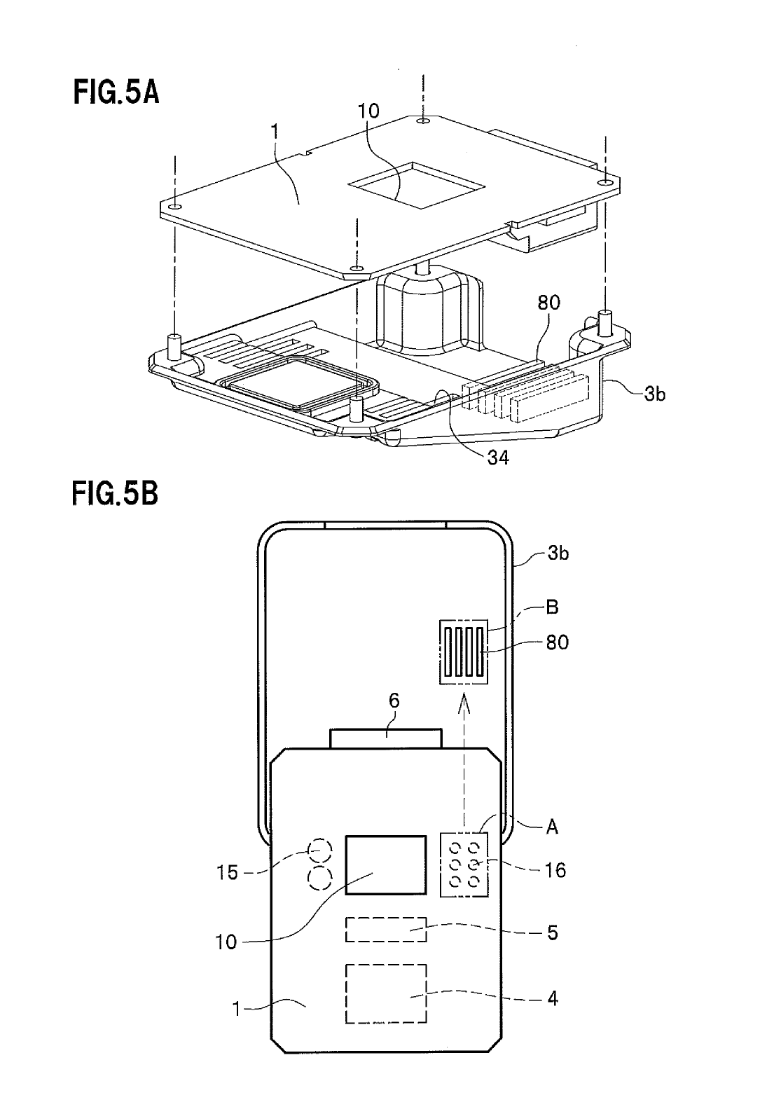

For example, as shown in FIGS. 5A and 5B, the in-vehicle camera 100 may be configured to have a fin member 80 for heat radiation on an inner surface of the base housing 3b arranged. Here, in the substrate 1, is arranged an element (a condenser 15) that has an installation height from the substrate 1 larger than a predetermined reference value, on one side around the opening 10; and another element (a device member 16) that has an installation height from the substrate 1 smaller than the predetermined reference value, on the other side around the opening 10. Note that the “predetermined reference value” is an installation height from the substrate 1 set according to a shape, a size, and the like of the in-vehicle camera 100, and is a value arbitrarily determined so that the substrate 1 provided with each element and the like can be included in the housing. And in the vacant space facing the other side around the opening 10, provided is the fin member 80 protruding forward the inner side from the housing (the base housing 3b).

Specifically, the opening 10 is arranged in the central area in the lateral direction on the substrate 1, and the condenser 15 with a predetermined length is arranged on the right side around the opening 10 when facing to the frontward of the in-vehicle camera 100 (the left side in FIG. 5B). On the left side around the opening 10 when facing to the frontward of the in-vehicle camera 100 (the right side in FIG. 5B), the element member 16 with a predetermined length is also arranged.

Additionally, the fin member 80 is arranged at the part (area B) of the base housing 3b facing to, when the substrate 1 is housed within the housing 3, the part (area A) where the element member 16 is arranged.

The fin member 80 is made of plurality of planar materials each extending in the longitudinal direction on the base housing 3b. Here are aligned a plural of (here, four) planar materials parallel to each other in the lateral direction on the base housing 3b. The fin member 80 has a predetermined height from the inner bottom of the base housing 3b and protrudes forward the substrate 1. The form, height, or the like of the fin member 80 is, preferably properly adjusted according to the form, size, and the like of the in-vehicle camera 100.

Thus, including the fin members 80 can increase the area of the inner surface (the portion of the area B) of the base housing 3b and make it easy to radiate the heat generated at the element member 16.

Though the above mentioned embodiment is structured such that the camera body 2 is arranged in the housing 3 by inserting the part of the camera body 2 into the opening 10, another structure may be allowable such that the part of the camera body 2 is not inserted into the opening 10, only if the camera body 2 is arranged at the position of the opening 10. Even in this case, the camera body 2 also makes the thickness of the in-vehicle camera 100 smaller because the camera body 2 includes none of a mirror and an attachment. Furthermore, since this structure enables the FPC7 to pass through the opening 10 just under the camera body 2 to connect with the first connector 5, the FPC7 can be shorter and easy to connect with the first connector 5.

In another embodiment, the in-vehicle camera 100 may be structured to be provided with a groove 34 for heat radiation in the bottom surface of the base housing 3b. The groove 34 is preferably a through hole. The groove 34 may be formed, for example, as plural grooves lined up in the lateral direction on the base housing 3b, each groove extending by a predetermined width in the longitudinal direction on the base housing 3b. Arranging the grooves 34 in the bottom face of the base housing 3b further improves the heat-radiating performance. Such grooves may be also arranged at the front end surface or the rear end surface of the in-vehicle camera 100. That is, at the front end surface or the rear end surface of the in-vehicle camera 100, plural of the grooves with the shape extending along the bottom-to-up direction by a predetermined width may be formed in the lateral direction.

In yet another embodiment, the in-vehicle camera 100 may be structured to include the cover housing 3a having a slope becoming thinner in the direction from the rear end to the front end. This structure enables the housing 3 to become gradually thinner in the direction from the predetermined position at the backward (rear end) to the frontward (front end) except the part where the camera body 2 is arranged in the in-vehicle camera 100.

The arrangement, size, or the like of the opening 10 of the substrate 1, the camera body 2, the processing-circuit element 4, or the like are described as one of the examples in the above mentioned embodiment and may be appropriately modified according to the configuration of the in-vehicle camera 100.

What is claimed is:

1. An in-vehicle camera comprising:
a substrate provided with an opening;
a camera body arranged at a position of the opening of the substrate; and
a housing including the substrate and the camera body.

2. The in-vehicle camera according to claim 1, wherein
the camera body is arranged in the housing, with a part of the camera body being inserted into the opening.

3. The in-vehicle camera according to claim 1, wherein
the housing comprising:
a base housing supporting the substrate; and
a cover housing facing to the base housing and supporting the camera body, wherein
the cover housing is provided with a lens window part for the camera body, the lens window part protruding from a surface of the cover housing; and
the housing is formed to become smaller in thickness thereof in the direction from an front end position of the lens window part toward an front end of the housing.

4. The in-vehicle camera according to claim 1, wherein
a processing-circuit element of the in-vehicle camera contacts the housing via a heat-radiating member.

5. The in-vehicle camera according to claim 4, wherein
the housing comprises:
a base housing supporting the substrate, and
a cover housing facing to the base housing and supporting the camera body; and
the processing-circuit element contacts the base housing.

6. The in-vehicle camera according to claim 5, wherein
the camera body is fixed on a windshield, and
the cover housing faces the windshield.

7. The in-vehicle camera according to claim 1, wherein
the substrate is provided with:
the opening being arranged in a central area;
a first element arranged on one side around the opening, the first element being larger than a predetermined reference value in installation height thereof from the substrate; and
a second element arranged on the other side around the opening, the second element being smaller than the predetermined reference value in installation height thereof from the substrate, and wherein
a fin member is provided in a space facing the other side around the opening, and protruding from the housing toward the inner side.

8. The in-vehicle camera according to claim 1, wherein
a length in a longitudinal direction of the substrate is 70 to 80 mm,
a length in a lateral direction of the substrate is 50 to 60 mm,
a length in a longitudinal direction of the opening is 10 to 20 mm,
a length in a lateral direction of the opening is 15 to 25 mm.

9. The in-vehicle camera according to claim 2, wherein
the housing comprising:
a base housing supporting the substrate; and
a cover housing facing to the base housing and supporting the camera body, wherein
the cover housing is provided with a lens window part for the camera body, the lens window part protruding from a surface of the cover housing; and
the housing is formed to become smaller in thickness thereof in the direction from an front end position of the lens window part toward an front end of the housing.

10. The in-vehicle camera according to claim 2, wherein
a processing-circuit element of the in-vehicle camera contacts the housing via a heat-radiating member.

11. The in-vehicle camera according to claim 10, wherein
the housing comprises:
a base housing supporting the substrate, and
a cover housing facing to the base housing and supporting the camera body; and
the processing-circuit element contacts the base housing.

12. The in-vehicle camera according to claim 11, wherein
the camera body is fixed on a windshield, and
the cover housing faces the windshield.

13. The in-vehicle camera according to claim 3, wherein
a processing-circuit element of the in-vehicle camera contacts the housing via a heat-radiating member.

14. The in-vehicle camera according to claim 9, wherein
a processing-circuit element of the in-vehicle camera contacts the housing via a heat-radiating member.

15. The in-vehicle camera according to claim 2, wherein
the substrate is provided with:
the opening being arranged in a central area;
a first element arranged on one side around the opening, the first element being larger than a predetermined reference value in installation height thereof from the substrate; and
a second element arranged on the other side around the opening, the second element being smaller than the predetermined reference value in installation height thereof from the substrate, and wherein
a fin member is provided in a space facing the other side around the opening, and protruding from the housing toward the inner side.

16. The in-vehicle camera according to claim 3, wherein
the substrate is provided with:
the opening being arranged in a central area;
a first element arranged on one side around the opening, the first element being larger than a predetermined reference value in installation height thereof from the substrate; and
a second element arranged on the other side around the opening, the second element being smaller than the predetermined reference value in installation height thereof from the substrate, and wherein
a fin member is provided in a space facing the other side around the opening, and protruding from the housing toward the inner side.

17. The in-vehicle camera according to claim 4, wherein
the substrate is provided with:
the opening being arranged in a central area;
a first element arranged on one side around the opening, the first element being larger than a predetermined reference value in installation height thereof from the substrate; and
a second element arranged on the other side around the opening, the second element being smaller than the predetermined reference value in installation height thereof from the substrate, and wherein
a fin member is provided in a space facing the other side around the opening, and protruding from the housing toward the inner side.

18. The in-vehicle camera according to claim 9, wherein
the substrate is provided with:
the opening being arranged in a central area;
a first element arranged on one side around the opening, the first element being larger than a predetermined reference value in installation height thereof from the substrate; and
a second element arranged on the other side around the opening, the second element being smaller than the predetermined reference value in installation height thereof from the substrate, and wherein
a fin member is provided in a space facing the other side around the opening, and protruding from the housing toward the inner side.

19. The in-vehicle camera according to claim 10, wherein
the substrate is provided with:
the opening being arranged in a central area;
a first element arranged on one side around the opening, the first element being larger than a predetermined reference value in installation height thereof from the substrate; and
a second element arranged on the other side around the opening, the second element being smaller than the predetermined reference value in installation height thereof from the substrate, and wherein
a fin member is provided in a space facing the other side around the opening, and protruding from the housing toward the inner side.

20. The in-vehicle camera according to claim 13, wherein
the substrate is provided with:
the opening being arranged in a central area;
a first element arranged on one side around the opening, the first element being larger than a predetermined reference value in installation height thereof from the substrate; and
a second element arranged on the other side around the opening, the second element being smaller than the predetermined reference value in installation height thereof from the substrate, and wherein
a fin member is provided in a space facing the other side around the opening, and protruding from the housing toward the inner side.
